(19) United States
(12) Patent Application Publication
(10) Pub. No.: US 2013/0258546 A1
(43) Pub. Date: Oct. 3, 2013

(54) MULTILAYER CERAMIC ELECTRONIC COMPONENT AND FABRICATION METHOD THEREOF

(71) Applicants: Chan Kong KIM, Suwon (KR); Jin Yung RYU, Suwon (KR); Jun AH, Suwon (KR); Yong Joon KO, Suwon (KR); Woo Kyung SUNG, Suwon (KR); Jong Rock LEE, Suwon (KR)

(72) Inventors: Chan Kong KIM, Suwon (KR); Jin Yung RYU, Suwon (KR); Jun AH, Suwon (KR); Yong Joon KO, Suwon (KR); Woo Kyung SUNG, Suwon (KR); Jong Rock LEE, Suwon (KR)

(73) Assignee: SAMSUNG ELECTRO-MECHANICS CO., LTD., Suwon (KR)

(21) Appl. No.: 13/827,258

(22) Filed: Mar. 14, 2013

(30) Foreign Application Priority Data
Mar. 30, 2012 (KR) 10-2012-0033417

(51) Int. Cl. H01G 4/12; H01G 4/008

(52) U.S. Cl. CPC H01G 4/12; H01G 4/008
USPC 361/301.4; 156/89.18; 156/89.16

(57) ABSTRACT

There are provided a multilayer ceramic electronic component and a fabrication method thereof. The multilayer ceramic component includes a ceramic main body in which internal electrodes and dielectric layers are alternately laminated; external electrodes formed on outer surfaces of the ceramic main body; intermediate layers formed on the external electrodes and including one or more selected from the group consisting of nickel, copper, and a nickel-copper alloy; and plating layers formed on the intermediate layers, whereby infiltration of a plating solution can be prevented.

### CROSS-REFERENCE TO RELATED APPLICATIONS

This application claims the priority of Korean Patent Application No. 10-2012-0033417 filed on Mar. 30, 2012, in the Korean Intellectual Property Office, the disclosure of which is incorporated herein by reference.

### BACKGROUND OF THE INVENTION

1. Field of the Invention

The present invention relates to a multilayer ceramic electronic component and, more particularly, to a multilayer ceramic electronic component capable of preventing a plating solution from infiltrating thereinto.

2. Description of the Related Art

In general, an electronic component using a ceramic material, such as a capacitor, an inductor, a piezoelectric element, a varistor, a thermistor, or the like, includes a ceramic main body made of a ceramic material, internal electrodes formed within the ceramic main body, and external electrodes formed on surfaces of the ceramic main body such that they are connected to the internal electrodes.

Among ceramic electronic components, a multilayer ceramic capacitor includes a plurality of laminated dielectric layers, internal electrodes disposed to face each other with a dielectric layer interposed therebetween, and external electrodes electrically connected to the internal electrodes.

Multilayer ceramic capacitors are commonly used as components of mobile communications devices such as portable computers, PDAs (Personal Digital Assistants), mobile phones, and the like, due to advantages thereof such as small size, guaranteed high capacity, and ease of mountability.

Recently, as electronic products have been reduced in size and have developed multifunctionality, chip components have also become compact and highly multifunctional, such that a compact multilayer ceramic capacitor (MLCC) product having a high capacity is in demand.

In this case, reductions in the thickness of external electrodes may allow for increases in the capacitance of a compact multilayer ceramic capacitor (MLCC) while maintaining the same overall chip size.

Also, in order to allow a multilayer ceramic electronic component to be easily mounted on a substrate, nickel/tin (Ni/Sn) plating is performed on the external electrodes of the MLCC.

Here, a general electric deposition, or electroplating process, is performed, and in this case, a plating solution may infiltrate into the MLCC, or hydrogen gas generated during the plating process may degrade reliability of the MLCC.

Meanwhile, in order to solve the problem, a method of directly coating molten solder paste on the external electrodes has been devised, but in this case, copper (Cu) metal of the external electrodes may react with the molten solder paste to cause a leaching phenomenon, thereby separating the external electrodes from the multilayer ceramic electronic component.

In addition, in a multilayer condenser in which external electrodes are configured by a nickel layer, a copper layer, an intermediate nickel plating layer and a lead/tin plating layer, a copper oxide film is formed between the copper plating layer and the metal plating layers outside thereof, but it may be difficult to control equivalent series resistance (ESR).

### RELATED ART DOCUMENT

(Patent Document 1) Japanese Patent No. 3135754

### SUMMARY OF THE INVENTION

An aspect of the present invention provides a multilayer ceramic electronic component capable of preventing the infiltration of a plating solution.

According to an aspect of the present invention, there is provided a multilayer ceramic electronic component including: a ceramic main body in which internal electrodes and dielectric layers are alternately laminated; external electrodes formed on outer surfaces of the ceramic main body; intermediate layers formed on the external electrodes and including one or more selected from the group consisting of nickel, copper, and a nickel-copper alloy; and plating layers formed on the intermediate layers.

The external electrodes may include one or more selected form the group consisting of nickel and copper.

The intermediate layers may have an average thickness of 20 nm to 1000 nm, or may have an average thickness of 500 nm or less.

A ratio of an average thickness of the intermediate layers to an average thickness of the external electrodes may be 1 or less, or may be 0.1 or less.

The plating layers may include a nickel layer, and a tin layer or a tin-alloy layer formed on the nickel layer.

The intermediate layers may further include a copper oxide layer.

According to another aspect of the present invention, there is provided a method of fabricating a multilayer ceramic electronic component, the method including: laminating and sintering ceramic green sheets with internal electrode patterns formed thereon to form a ceramic main body in which dielectric layers and internal electrodes are alternately laminated; forming external electrodes on outer surfaces of the ceramic main body; forming intermediate layers including one or more selected from the group consisting of nickel, copper, and a nickel-copper alloy on the external electrodes; and forming plating layers on the intermediate layers.

The intermediate layers may be formed by a thermal treatment at 100° C. to 600° C. or at 200° C. to 300° C. under an air atmosphere or an oxidation atmosphere.

The intermediate layers may further include a copper oxide layer.

The intermediate layers may have an average thickness of 20 nm to 1000 nm or may have an average thickness of 500 nm or less.

A ratio of an average thickness of the intermediate layers to an average thickness of the external electrodes may be 1 or less or may be 0.1 or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a multilayer ceramic capacitor (MLCC) according to first and second embodiments of the present invention;

FIG. 2 is a cross-sectional view of the MLCC, taken along line A-A′ in FIG. 1 according to the first embodiment of the present invention;

FIG. 3 is a cross-sectional view of the MLCC, taken along line A-A′ in FIG. 1 according to the second embodiment of the present invention; and

FIG. 4 is a flowchart illustrating a process of manufacturing an MLCC according to a third embodiment of the present invention.

### DETAILED DESCRIPTION OF THE PREFERRED EMBODIMENT

Embodiments of the present invention will now be described in detail with reference to the accompanying drawings.

The invention may be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

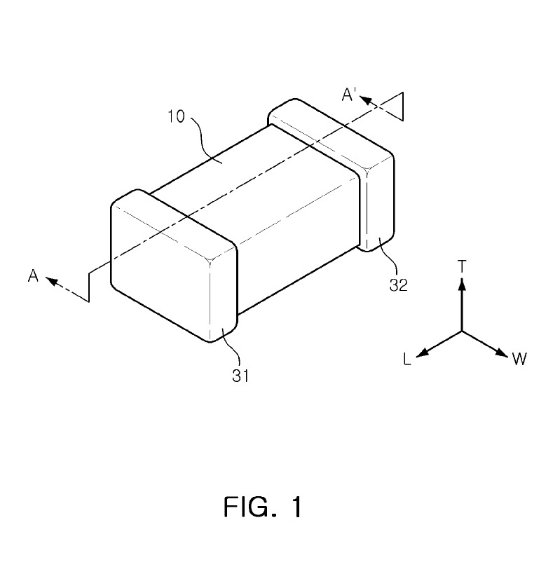

FIG. 1 is a schematic perspective view of a multilayer ceramic capacitor (MLCC) according to first and second embodiments of the present invention.

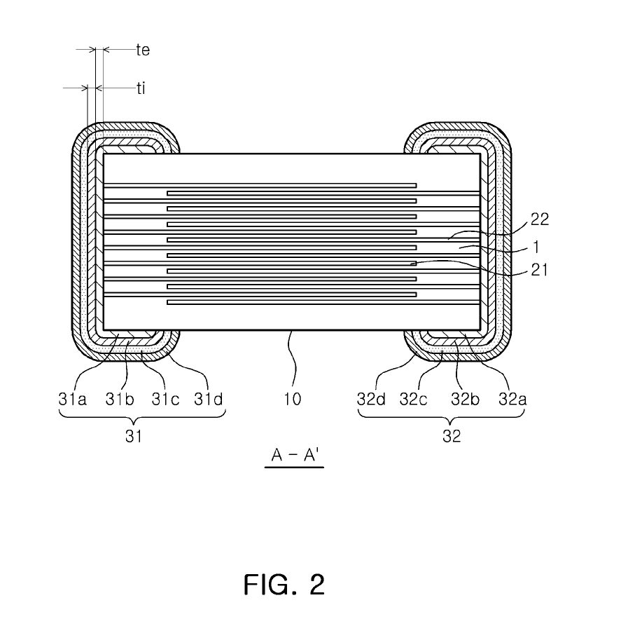

FIG. 2 is a cross-sectional view of the MLCC, taken along line A-A′ according to the first embodiment of the present invention.

With reference to FIGS. 1 and 2, the multilayer ceramic electronic component according to the first embodiment of the present invention may include a ceramic main body 10 in which internal electrodes 21 and 22 and dielectric layers 1 are alternately laminated; external electrodes 31a and 32a formed on outer surfaces of the ceramic main body 10; intermediate layers 31b and 32b formed on the external electrodes 31a and 32a and including one or more selected from the group consisting of nickel, copper, and a nickel-copper alloy; and plating layers 31c, 31d, 32c, 32d formed on the intermediate layers.

Hereinafter, a multilayer ceramic electronic component according to an embodiment of the present invention will be described by using a multilayer ceramic capacitor (MLCC) as an example, but the present invention is not limited thereto.

In the MLCC according to the embodiment of the present invention, it may be defined that a ‘length direction’ of the MLCC is the ‘L’ direction, a ‘width direction’ is the ‘W’ direction, and a ‘thickness direction’ is the ‘T’ direction in FIG. 1. Here, the ‘thickness direction’ may have the same concept as a ‘lamination direction’ in which dielectric layers are stacked.

According to an embodiment of the present invention, a raw material for forming the dielectric layer 1 is not particularly limited, so long as sufficient capacitance may be obtained thereby. For example, a barium titanate (BaTiO₃) powder may be used therefor.

As for the material of the dielectric layer 1, various materials such as a ceramic additive, an organic solvent, a plasticizer, a binder, a dispersant, or the like, may be added to the powder made of barium titanate (BaTiO₃), or the like, according to the purpose of the present invention.

An average particle diameter of the ceramic powder used to form the dielectric layer 1 is not particularly limited and may be adjusted to achieve the object of the present invention. For example, the average particle diameter of the ceramic powder may be adjusted to be 400 nm or less.

A material for forming the plurality of internal electrodes 21 and 22 is not particularly limited. For example, the internal electrodes 21 and 22 may be formed by using a conductive paste made of one or more of silver (Ag), lead (Pb), platinum (Pt), nickel (Ni), and copper (Cu).

Also, the plurality of internal electrodes 21 and 22 may include a ceramic material, and here, the ceramic material is not particularly limited. For example, barium titanate (BaTiO₃) may be used.

In order to form capacitance, the external electrodes 31a and 32a may be formed on outer surfaces of the ceramic main body 10 and electrically connected to the internal electrodes 21 and 22.

The external electrodes 31a and 32a may be formed of the same conductive material as that of the internal electrodes 21 and 22, but the present invention is not limited thereto. For example, the external electrodes 31a and 32a may be made of copper (Cu), silver (Ag), nickel (Ni), or the like.

The external electrodes 31a and 32a may be formed by applying a conductive paste prepared by adding glass frit to metal powder to the outer surfaces of the ceramic main body, and then firing the same.

With reference to FIG. 2, the MLCC according to the first embodiment of the present invention may include the intermediate layers 31b and 32b formed on the external electrodes 31a and 32a and including one or more selected from the group consisting of nickel, copper, and a nickel-copper alloy.

According to the first embodiment of the present invention, the inclusion of the intermediate layers 31b and 32b may prevent a degradation of reliability due to an infiltration of a plating solution into a high capacity MLCC.

In general, as the thickness of an external electrode is reduced, a plating solution may infiltrate into a ceramic main body when a plating layer is formed on the external electrode or when hydrogen gas, generated during a plating process, may degrade reliability of a multilayer ceramic electronic component.

However, according to the first embodiment of the present invention, the intermediate layers 31b and 32b prevent the plating solution and the hydrogen gas from infiltrating into the ceramic main body 10, thus enhancing reliability thereof.

The intermediate layers 31b and 32b may include one or more selected from the group consisting of nickel, copper, and a nickel-copper alloy, but the present invention is not limited thereto.

The intermediate layers 31b and 32b may be formed by thermally treating one or more selected from the group consisting of nickel, copper, and a nickel-copper alloy at 100° C. to 600° C. under an air atmosphere or an oxidation atmosphere, after the external electrodes 31a and 32a are fired.

When the temperature for the thermal treatment is lower than 100° C., the intermediate layers 31b and 32b including one or more selected from the group consisting of nickel, copper, and a nickel-copper alloy may not be sufficiently formed.

Meanwhile, when the temperature for the thermal treatment exceeds 600° C., it is too high, and the intermediate layers 31b and 32b may be formed to be overly thick, causing a problem with electric characteristics, e.g., ESR (equivalent series resistance).

The thermal treatment may be performed under an air atmosphere or an oxidation atmosphere after the external electrodes 31a and 32a are fired and before the plating process is performed, and here, since the thermal treatment process is performed at a temperature of 200° C. to 300° C., the effect in enhancing reliability can be excellent.

According to the first embodiment of the present invention, an average thickness ti of the intermediate layers 31b and 32b is not particularly limited. For example, the average thickness ti of the intermediate layers 31b and 32b may range from 20 nm to 1000 nm, but in particular, it may be less than 500 nm.

The thickness ti of the intermediate layers 31b and 32b may refer to a height of the intermediate layers 31b and 32b formed on the external electrodes 31a and 32a at both end portions of the MLCC in the length direction, and a height of the intermediate layers 31b and 32b formed on an upper surface or a lower surface of the MLCC in the thickness direction, and may refer to an average thickness thereof.

In the first embodiment of the present invention, the average thickness ti of the intermediate layers 31b and 32b may be measured by scanning an image of a cross-section of the ceramic main body 10 taken in the length and thickness directions thereof by using a scanning electron microscope (SEM) or a transmission electron microscope (TEM), as shown in FIG. 2.

For example, with respect to an external electrode region captured by scanning the image of the cross-section of the MLCC, using the SEM or the TEM, in the length and thickness directions (L-T) cut in a central portion thereof in the width (W) direction as shown in FIG. 2, the average thickness of the intermediate layers 31b and 32b may be measured.

By adjusting the average thickness ti of the intermediate layers 31b and 32b to range from 20 nm to 1000 nm, the plating solution or the hydrogen gas can be prevented from infiltrating into the ceramic main body 10, thus preventing a degradation of reliability.

In the case in which the average thickness of the intermediate layers 31b and 32b is less than 20 nm, they would be too thin to sufficiently prevent the infiltration of the plating solution and the hydrogen gas into the ceramic main body 10, failing to achieve the effect of enhancing reliability.

In the case in which the average thickness of the intermediate layers 31b and 32b exceeds 1000 nm, they would be too thick, causing a problem with electrical characteristics, e.g., ESR.

In particular, by adjusting the average thickness of the intermediate layers 31b and 32b to be 500 nm or less, the effect of enhancing reliability can be further increased.

Also, according to the first embodiment of the present invention, a ratio of the average thickness ti of the intermediate layers 31b and 32b to an average thickness to of the external electrodes 31a and 32a may be 1 or less, and in particular, 0.1 or less.

Here, the thickness te of the external electrodes 31a and 32a may refer to a height of the external electrodes 31a and 32a at both end portions of the MLCC in the length direction and a height of the external electrodes 31a and 32a formed on an upper surface or a lower surface of the MLCC in the thickness direction, and may refer to an average thickness thereof.

The average thickness te of the external electrodes 31a and 32a may be measured by scanning the image of the cross-section of the ceramic main body 10 taken in the length and thickness directions thereof by using a scanning electron microscope (SEM) or a transmission electron microscope (TEM) as shown in FIG. 2.

For example, with respect to an external electrode region captured by scanning the image of the cross-section of the MLCC, using the SEM or the TEM, in the length and thickness directions (L-T) cut in the central portion thereof in the width (W) direction as shown in FIG. 2, the average thickness te of the external electrodes 31a and 32a may be measured.

The ratio of the average thickness ti of the intermediate layers 31b and 32b to the average thickness te of the external electrodes 31a and 32a may be 1 or less. In particular, by adjusting the ratio to be 0.1 or less, even in the case of a super-capacity MLCC in which the average thickness te of the external electrodes 31a and 32a is small, an excellent level of reliability may be obtained.

When the ratio of the average thickness ti of the intermediate layers 31b and 32b to the average thickness te of the external electrodes 31a and 32a exceeds 1, the intermediate layers 31b and 32b would be too thick, causing a problem with electrical characteristics, e.g., ESR.

The MLCC according to the first embodiment of the present invention may include the plating layers 31c, 31d, 32c and 32d formed on the intermediate layers 31b and 32b.

The plating layers 31c, 31d, 32c and 32d may include a nickel layer, and a tin layer or a tin alloy layer formed on the nickel layer, but the present invention is not limited thereto and, the plating layers 31c, 31d, 32c and 32d may include only a nickel layer and a tin layer or a tin alloy layer.

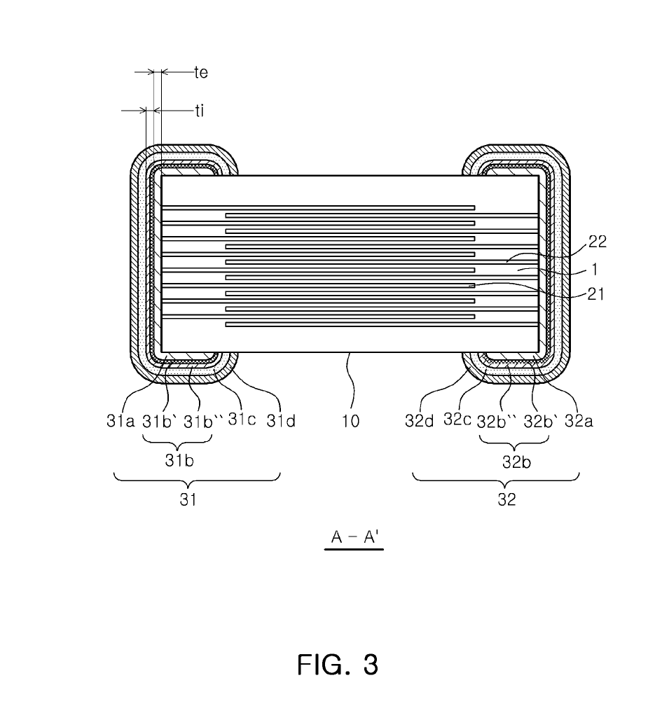

FIG. 3 is a cross-sectional view of the MLCC, taken along line A-A′ according to the second embodiment of the present invention.

With reference to FIG. 3, in the MLCC according to the second embodiment of the present invention, the intermediate layers 31b and 32b may further include copper oxide layers 31b′ and 32b′.

Namely, in the MLCC according to the second embodiment of the present invention, the intermediate layers 31b and 32b including the copper oxide layers 31b′ and 32b′ and metal layers 31b″ and 32b″ including one or more selected form the group consisting of nickel, copper, and a nickel-copper alloy may be formed on the external electrodes 31a and 32a.

The intermediate layers 31b and 32b including the copper oxide layers 31b′ and 32b′ and the metal layers 31b″ and 32b″ including one or more selected form the group consisting of nickel, copper, and a nickel-copper alloy, which are sequentially formed, are merely illustrative, and the intermediate layers 31b and 32b may include a plurality of layers therein.

According to the second embodiment of the present invention, since the intermediate layers 31b and 32b further include the copper oxide layers 31b′ and 32b′, the intermediate layers 31b and 32b may prevent a plating solution and hydrogen gas from infiltrating into the ceramic main body 10, thus further enhancing reliability.

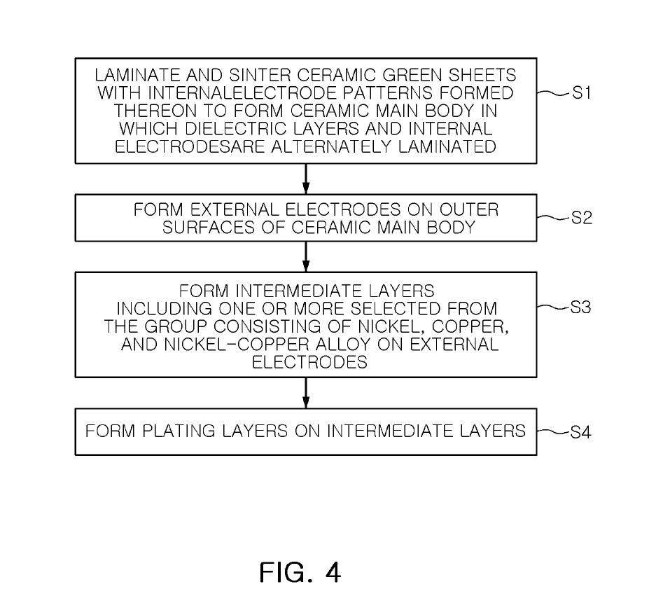

FIG. 4 is a flowchart illustrating a process of manufacturing an MLCC according to a third embodiment of the present invention.

With reference to FIG. 4, a method of fabricating a multilayer ceramic electronic component according to the third embodiment of the present invention may include: laminating and sintering ceramic green sheets with internal electrode patterns formed thereon to form a ceramic main body in which dielectric layers and internal electrodes are alternately laminated; forming external electrodes on outer surfaces of the ceramic main body; forming intermediate layers including one or more selected from the group consisting of nickel, copper, and a nickel-copper alloy on the external electrodes; and forming plating layers on the intermediate layers.

In the method of fabricating the multilayer ceramic electronic component according to the third embodiment of the present invention, first of all, a ceramic green sheet including a dielectric substance may be prepared.

In order to fabricate the ceramic green sheet, slurry is produced by mixing a ceramic powder, a binder, and a solvent, and made into a sheet having a thickness of a few μm through a doctor blade method.

Next, an internal electrode pattern may be formed on the ceramic green sheet by using a conductive paste for internal electrodes including a conductive metal powder and a ceramic powder.

Then, the green sheets with the internal electrode patterns formed thereon are laminated and sintered to form the ceramic main body in which the dielectric layers and the internal electrodes are alternately laminated.

Thereafter, the external electrodes may be formed on the outer surfaces of the ceramic main body.

The external electrodes may include one or more selected from the group consisting of nickel and copper.

Then, the intermediate layers including one or more selected from the group consisting of nickel, copper, a nickel-copper alloy may be formed on the external electrodes.

The intermediate layers may be formed by thermally treating one or more selected from the group consisting of nickel, copper, and a nickel-copper alloy at 100° C. to 600° C. under an air atmosphere or an oxidation atmosphere, after the external electrodes are formed and fired.

In this process, the intermediate layers 31b and 32b may further include the copper oxide layers 31b′ and 32b′.

The thermal treatment is performed under an air atmosphere or an oxidation atmosphere after the external electrodes 31a and 32a are fired and before the plating process is performed, and here, since the thermal treatment process is performed at 200° C. to 300° C., the effect of enhancing reliability can be increased.

Finally, the plating layers 31c, 31d, 32c and 32d are formed on the intermediate layers 31b and 32b through a plating process, thus fabricating the MLCC.

Descriptions of elements having the same characteristics as those of the multilayer ceramic electronic component according to the above-described embodiment of the present invention will be omitted.

Hereinafter, the present invention will be described in more detail based on Examples below, but the present invention is not limited thereto.

The Examples were manufactured to test whether ESR and reliability were enhanced according to the respective thicknesses of intermediate layers made of nickel, copper, or a nickel-copper alloy and formed on the external electrodes with respect to an MLCC fabricated to include external electrodes having average thicknesses of 10.2 μm and 20.5 μm, respectively, after being fired.

The MLCC according to the inventive Examples was fabricated through the following operations.

First, a slurry including a powder made of a material such as barium titanate (BaTiO₃), or the like, having an average particle diameter of 0.1 μm was applied to a carrier film and then dried to prepare a plurality of ceramic green sheets, thus forming the dielectric layers 1.

Next, a conductive paste for internal electrodes, including a conductive metal powder and a ceramic power, was prepared.

The conductive paste for internal electrodes was applied to the green sheets through screen printing to form internal electrodes, and 190 to 250-storied internal electrodes were laminated to form a lamination body.

Then, the lamination body was compressed and cut to generate a chip having a 0603 standard size, and the chip was fired at a temperature ranging from 1050° C. to 1200° C. under a reducing atmosphere of H₂ of 0.1% or less.

Thereafter, a process of forming external electrodes, forming intermediate layers on the external electrodes, and performing plating, and the like, were performed to fabricate a multilayer ceramic capacitor.

As a result of observing the cross sections of the multilayer ceramic capacitor samples, the average thicknesses of the external electrodes were 10.2 μm and 20.5 μm, and the average thicknesses of the intermediate layers ranged from 0.12 μm to 2.02 μm.

Comparative examples were fabricated in the same manner as those of the Examples, except that intermediate layers were not formed.

Table 1 below shows comparison of an average thickness of the external electrodes after firing, an average thickness of the intermediate layers, and ESR according to an average thickness ratio between the external electrodes and the intermediate layers.

ESR was measured at a frequency of 1 MHz to 3 MHz by using an impedance analyzer, and compared based on Comparative Examples 1 and 3, on which a thermal treatment was not performed and intermediate layers were not formed.

TABLE 1

| | Average | Average | | | |
|---|---|---|---|---|---|
| | Thickness (te) | Thickness (ti) | | | |
| | of External | of Intermediate | | | |
| | Electrodes | Layers (Cu—Ni | | | |
| Sample No. | (μm) | Layers ) (μm) | ti/te | ESR (mΩ) | |
| Comparative | 10.2 | 0.00 | 0.00 | 22 | — |
| Example 1 | | | | | |
| Example 1 | | 0.12 | 0.01 | 22 | Equal |
| Example 2 | | 0.55 | 0.05 | 24 | Equal |
| Example 3 | | 0.98 | 0.10 | 24 | Equal |
| Comparative | | 2.02 | 0.20 | 63 | Doubled |
| Example 2 | | | | | |
| Comparative | 20.5 | 0.00 | 0.00 | 25 | — |
| Example 3 | | | | | |
| Example 4 | | 0.15 | 0.01 | 27 | Equal |
| Example 5 | | 0.48 | 0.02 | 27 | Equal |
| Example 6 | | 1.00 | 0.05 | 28 | Equal |
| Comparative | | 1.99 | 0.10 | 58 | Doubled |
| Example 4 | | | | | |

With reference to Table 1, in comparison to Comparative Examples 1 and 3 in which intermediate layers are not formed, it can be seen that, in the case of Examples 1 to 6, satisfying the numerical value range of the present invention, ESR was equal.

Meanwhile, it can be seen that, in the case of Comparative Examples 2 and 4, outside of the numerical value range of the present invention, ESR was doubled to be problematic.

Table 2 below shows results obtained by evaluating reliability according to Examples of the present invention and Comparative Examples.

The evaluation of reliability was performed at a temperature of 105 at a rated voltage of 3 Vr over time.

TABLE 2

| | Average | Evaluation of | Evaluation of | Evaluation of |
|---|---|---|---|---|
| | Thickness (ti) | Reliability (2 hrs) | Reliability (4 hrs) | Reliability (6 hrs) |
| | of Intermediate | (Number of | (Number of | (Number of |
| | Layers (Cu—Ni | Defective MLCCs/ | Defective MLCCs/ | Defective MLCCs/ |
| Sample No. | Layers) (μm) | Total Number) | Total Number) | Total Number) |
| Comparative | 0.00 | 5/400 | 7/400 | 12/400 |
| Example 5 | | | | |
| Example 7 | 0.12 | 0/400 | 0/400 | 0/400 |
| Example 8 | 0.55 | 0/400 | 0/400 | 0/400 |
| Example 9 | 0.98 | 0/.400 | 0/.400 | 0/.400 |

With reference to Table 2, it can be seen that, in the case of Examples 7 to 9, satisfying the numerical value range of the present invention, reliability was secured.

However, in the case of Comparative Example 5 in which intermediate layers were not formed, it can be seen that reliability was degraded.

As set forth above, according to embodiments of the present invention, infiltration of a plating solution can be prevented by forming intermediate layers including one of more selected from the group consisting of nickel, copper, and a nickel-copper alloy or oxide between external electrodes and plating layers, thereby realizing a high capacity multilayer ceramic electronic component having improved reliability.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component comprising:
a ceramic main body in which internal electrodes and dielectric layers are alternately laminated;
external electrodes formed on outer surfaces of the ceramic main body;
intermediate layers formed on the external electrodes and including one or more selected from the group consisting of nickel, copper, and a nickel-copper alloy; and
plating layers formed on the intermediate layers.

2. The multilayer ceramic electronic component of claim 1, wherein the external electrodes include one or more selected form the group consisting of nickel and copper.

3. The multilayer ceramic electronic component of claim 1, wherein the intermediate layers have an average thickness of 20 nm to 1000 nm.

4. The multilayer ceramic electronic component of claim 1, wherein the intermediate layers have an average thickness of 500 nm or less.

5. The multilayer ceramic electronic component of claim 1, wherein a ratio of an average thickness of the intermediate layers to an average thickness of the external electrodes is 1 or less.

6. The multilayer ceramic electronic component of claim 1, wherein a ratio of an average thickness of the intermediate layers to an average thickness of the external electrodes is 0.1 or less.

7. The multilayer ceramic electronic component of claim 1, wherein the plating layers include a nickel layer, and a tin layer or a tin-alloy layer formed on the nickel layer.

8. The multilayer ceramic electronic component of claim 1, wherein the intermediate layers further include a copper oxide layer.

9. A method of fabricating a multilayer ceramic electronic component, the method comprising:
laminating and sintering ceramic green sheets with internal electrode patterns formed thereon to form a ceramic main body in which dielectric layers and internal electrodes are alternately laminated;
forming external electrodes on outer surfaces of the ceramic main body;
forming intermediate layers including one or more selected from the group consisting of nickel, copper, and a nickel-copper alloy on the external electrodes; and
forming plating layers on the intermediate layers.

10. The method of claim 9, wherein the intermediate layers are formed by a thermal treatment at 100° C. to 600° C. under an air atmosphere or an oxidation atmosphere.

11. The method of claim 9, wherein the intermediate layers are formed by a thermal treatment at 200° C. to 300° C. under an air atmosphere or an oxidation atmosphere.

12. The method of claim 9, wherein the intermediate layers further include a copper oxide layer.

13. The method of claim 9, wherein the intermediate layers have an average thickness of 20 nm to 1000 nm.

14. The method of claim 9, wherein the intermediate layers have an average thickness of 500 nm or less.

15. The method of claim 9, wherein a ratio of an average thickness of the intermediate layers to an average thickness of the external electrodes is 1 or less.

16. The method of claim 9, wherein a ratio of an average thickness of the intermediate layers to an average thickness of the external electrodes is 0.1 or less.
